(19) United States
(12) Patent Application Publication
(10) Pub. No.: US 2009/0011100 A1
(43) Pub. Date: Jan. 8, 2009

(54) Process and apparatus for producing shaped frozen confections

(75) Inventor: Paul Michael Doehren, Sharnbrook (GB)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/217,236

(22) Filed: Jul. 2, 2008

(30) Foreign Application Priority Data
Jul. 4, 2007 (EP) EP07111709
Jul. 4, 2007 (EP) EP07111710

(51) Int. Cl. A23P 1/12; A23G 3/06

(52) U.S. Cl. 426/515; 99/485; 425/286

(57) ABSTRACT

A process for shaping a frozen confectionery product is provided, the process comprising: extruding a frozen confection from a filling means into a cavity defined by a mould block and a base; moving the mould block relative to the base; and removing the frozen confection from the cavity, characterized in that the cross-section of the base, when viewed along the direction of relative motion of the cavity and the cutting means, is not a straight line. An apparatus for performing the process is also provided.

### TECHNICAL FIELD OF THE INVENTION

The present invention relates to a process and apparatus for producing frozen confectionery products that are shaped in three dimensions. In particular, it relates to an extrusion process.

### BACKGROUND OF THE INVENTION

There is a demand for frozen confectionery products with interesting and distinctive shapes. Products that are shaped in two dimensions have been known for many years. They are usually produced by an “extrude and cut” process, in which partially frozen ice cream is extruded though a nozzle and cut by a wire into portions of uniform thickness. The two dimensional shape arises from the shape of the nozzle, but there is no possibility of shaping in the third dimension using this process.

Three-dimensional shaped products can be produced by moulding. However, moulding processes have drawbacks, in particular the tendency of the ice cream to stick to the mould. U.S. Pat. No. 4,413,461 discloses a method of shaping ice cream. The problem of ice cream sticking to the mould is solved by blowing air between the mould and the ice cream or by use of a release film between the mould and the ice cream. EP-A-0827696 discloses a method for moulding three dimensional food products in which the mould is at a very low temperature, thereby reducing the adhesion between the product and the mould. However, both of these solutions add cost and complexity to the process. Therefore there remains a need for a simple method of producing frozen confectionery products that are shaped in three dimensions.

### BRIEF DESCRIPTION OF THE INVENTION

We have developed a simple process for making frozen confectionery products that are shaped in three dimensions, based on the extrude and cut process. Accordingly, in a first aspect the present invention provides a process for shaping a frozen confectionery product, the process comprising:
extruding a frozen confection from a filling means into a cavity defined by a mould block and a base;
moving the mould block relative to the base; and
removing the frozen confection from the cavity
   characterized in that the cross-section of the base, when viewed along the direction of relative motion of the cavity and the cutting means, is not a straight line.

Products obtained and obtainable by the process of the invention are also provided.

In a second aspect the present invention provides an apparatus for shaping a frozen confectionery product, the apparatus comprising:
a mould block and a base which define a cavity,
a filling means for filling the cavity with frozen confection;
means for moving the mould block relative to the base;
means for removing the frozen confection from the cavity;
   characterized in that the cross-section of the base, when viewed along the direction of relative motion of the cavity and the cutting means, is not a straight line.

WO-A 99/65325 discloses a process in which frozen confection pieces are produced by extruding a frozen confection from a filling means into a cavity defined by a mould block and a base, and then moving the mould block relative to the base, thereby opening the cavity so that the frozen confection piece can be removed. In this case, the base is a flat plate, i.e. the cross-section of the base, when viewed along the direction of relative motion of the cavity and the cutting means, is a straight line. However, this document addresses the unrelated problem of producing extruded products that contain large amounts of inclusions, and makes no mention of the possibility of producing products that are shaped in three dimensions.

In the present invention, the base of the cavity is not a plane, so the corresponding surface of the frozen confection piece is not planar either. Thus the process of the invention allows frozen confections that are shaped in three dimensions to be formed. The base and corresponding section of the mould block must have translational symmetry along the direction of relative motion of the mould block and base (i.e. the base has a constant cross-section when viewed along this direction). Thus shapes such as a half cylinder can be produced by the process of the invention, but not, for example, a hemisphere.

The frozen confection which is filled into the cavity is of a consistency such that it can be extruded from the nozzle and filled into the cavity, but which is solid enough that it retains its shape on removal from the cavity. The frozen confection is preferably partially frozen ice cream, typically at a temperature of about −5 to −15° C., most preferably from −9 to −12° C.

Preferably the base is concave and the corresponding section of the mould block is convex, when viewed along the direction of relative motion of the base and the mould block, so that the shaped surface of the frozen confection is convex.

Preferably a plurality of cavities is located in a rotating carousel and the thickness of the carousel varies radially across the cavity, thereby providing the shape of the mould block and cavity, and hence the shaped product.

Optionally, the filling means and the opening of the cavity opposite to the base through which the frozen confection is filled into the cavity also has a cross-section which is not a straight line when viewed along the direction of relative motion of the mould block and the base. This enables the other side of the product to be shaped in an analogous manner.

### DETAILED DESCRIPTION OF THE INVENTION

The present invention will be further by reference to the figures wherein:

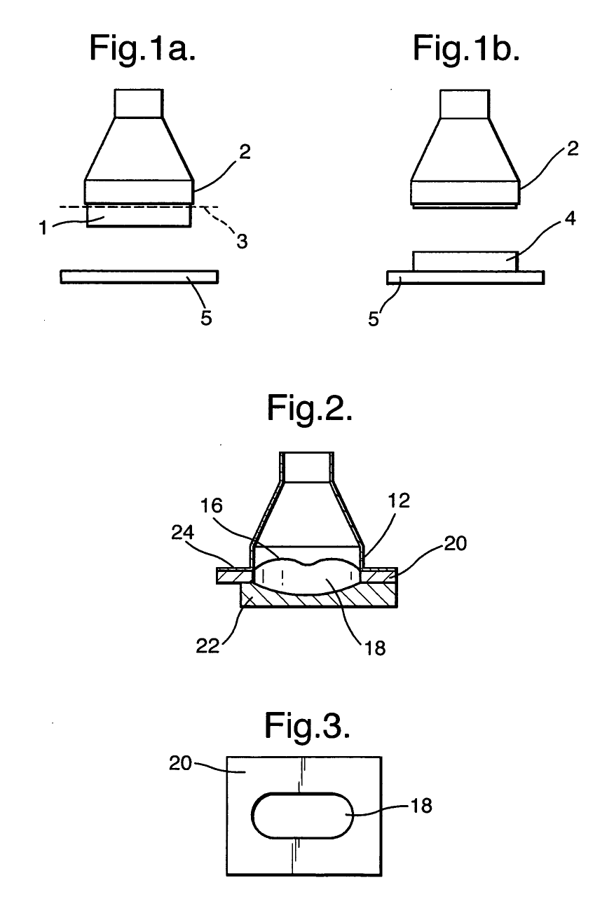

FIG. 1 shows the conventional extrude and cut process.

FIG. 2 is a cross-sectional view of a mould block and corresponding base according to the invention.

FIG. 3 shows a top view of the cavity of FIG. 2.

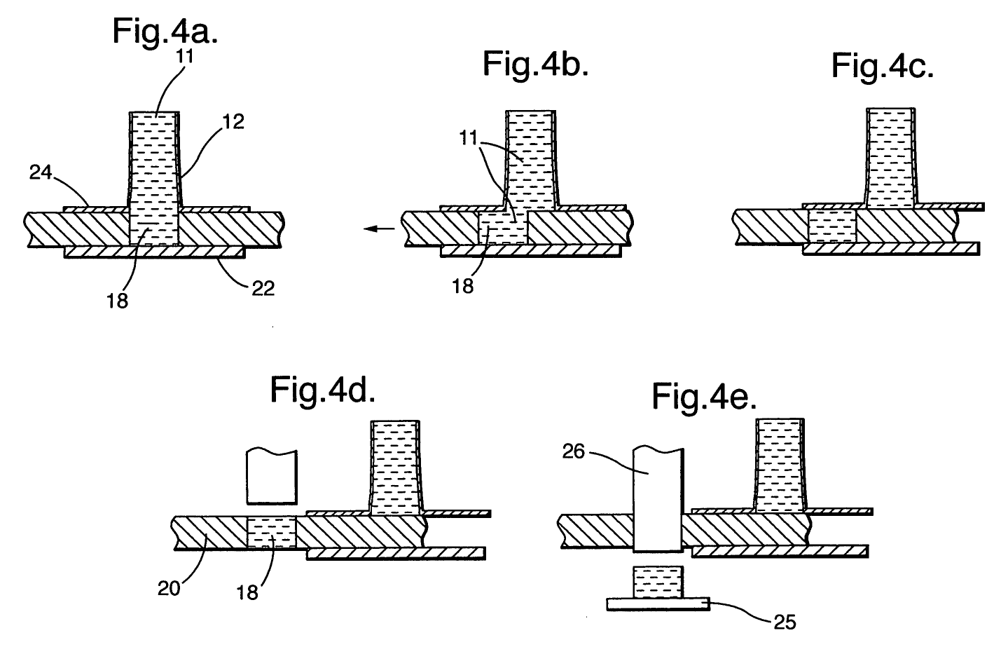

FIG. 4 shows a side view of the nozzle and cavity at different stages through the process of the invention.

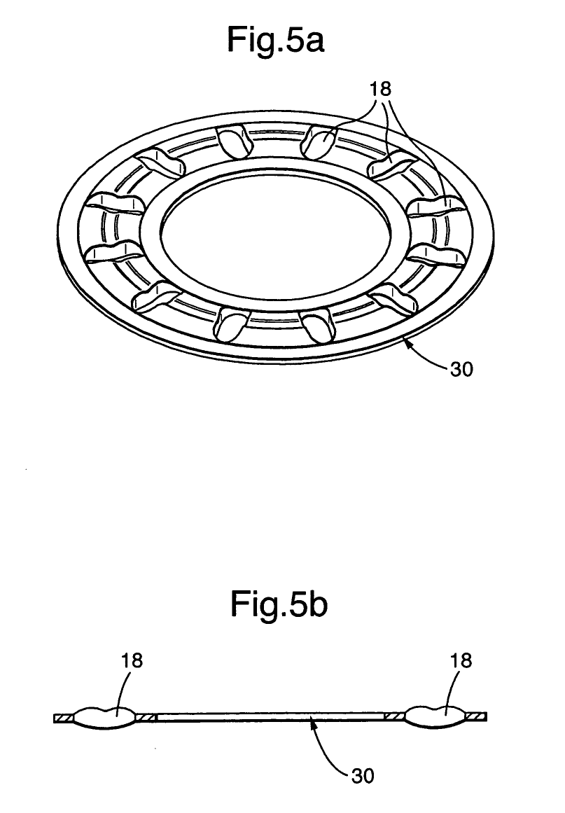

FIG. 5 shows a preferred embodiment where the cavities are located in a rotating carousel.

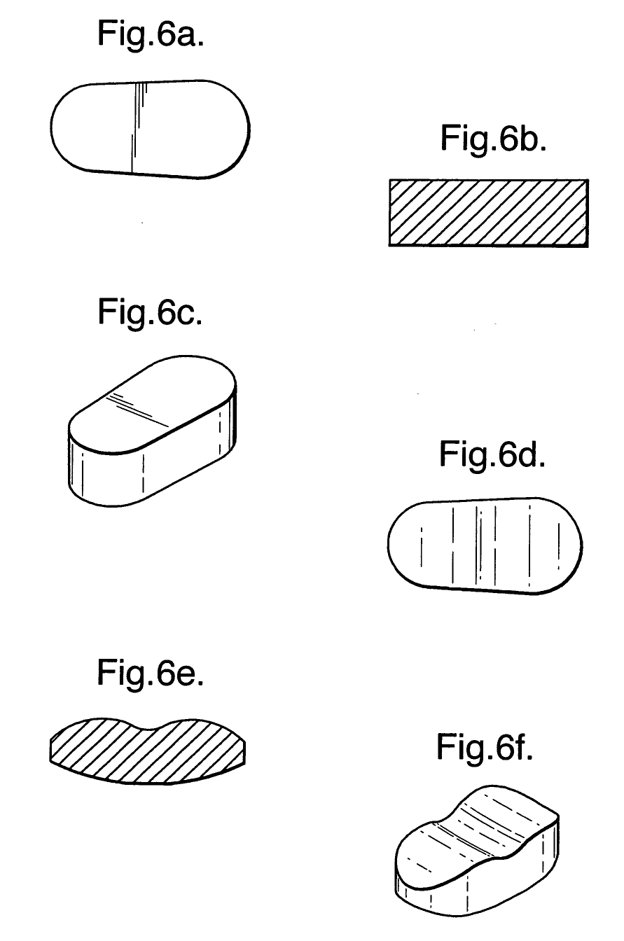

FIG. 6 compares a product shaped by the conventional extrude and cut process with a shaped product produced according to the present invention.

FIGS. 1(a) and (b) are schematic diagrams showing the conventional “extrude and cut” process. Extrude and cut-type processes for producing frozen confection products are well-known in the field of frozen confectionery manufacture and are described in, for example, “The Science of Ice Cream”, C. Clarke, Royal Society of Chemistry, Cambridge, UK, 2004, p 93-94. Frozen confections (which include ice cream, water ice, frozen yoghurt and the like) are made by freezing and optionally aerating a pasteurised mix of ingredients such as water, fat, sweetener, protein (normally milk proteins), and optionally other ingredients such as emulsifiers, stabilisers, colours and flavours. The frozen confection 1 can then be formed into products by extrusion through a nozzle 2. The frozen confection 1 is cut into pieces 4 by the cutter 3. The extruded and cut frozen confection pieces 4 drop onto a conveyor 5, which transports them through a hardening tunnel.

FIG. 2 is a cross-sectional view of a filling means and cavity according to the invention, viewed along the direction of relative motion of the mould block and base. The frozen confection is extruded through a nozzle 12 into the cavity 18 formed by a mould block 20 and a base 22. The nozzle end has a flange 24 which surrounds and seals the cavity as it is filled with the frozen confection, so that the frozen confection cannot flow out of the cavity. The base is not be flat, but is shaped in cross-section. In the embodiment shown the base is concave, though any suitable shape may be used. Once the cavity has been filled, the mould block is moved relative to the base in a direction perpendicular to the paper.

FIG. 3 is a top view of the cavity 18 in the mould block 20 shown in FIG. 2. A cavity having straight sides and rounded ends when viewed from above is shown. However any suitable shape may be chosen, for example circular, oval, star-shaped, or even the shape of an animal, cartoon character, face, hand, foot etc. These sorts of 2D shaped products have been produced for many years by the conventional extrude and cut process, using a nozzle with the appropriate cross-section.

FIG. 4 shows side views of the nozzle and cavity through the process according to the invention. In this view, the shaped cross-sections of the of the mould block and base are not visible. In FIG. 4(a) the nozzle 12 and cavity 18 are aligned while the cavity is filled. The flange 24 prevents leakage of the frozen confection from the cavity during filling. Once the cavity is filled with frozen confection 11, the mould block 20 is moved relative to the base 22 as shown in FIGS. 4(b) and (c). The base 22 is fixed relative to the nozzle so that the bottom of the cavity 18 is opened when the mould block 20 is moved whilst preserving the corresponding shaped side of the frozen confection piece (FIG. 4(d)). This allows the shaped frozen confection to be removed (FIG. 4(e)) by applying a downward force e.g. by blowing with air, or gently pushing the frozen confection with a plunger 26 from above through the opening at the top of the cavity. FIG. 4 shows an embodiment wherein the nozzle end is in close proximity to the opening of the cavity, so that the relative movement between the nozzle end and the cavity shears the frozen confection and thereby cuts the flow of frozen confection, in a manner similar to that of the cutting wire in the conventional extrude and cut process shown in FIG. 1. The nozzle end may also have a cross-section which, when viewed along the direction of relative motion of the mould block and the base means, is not a straight line. This enables the other side of the product to be shaped by an analogous process. When the shaped frozen confection is removed from the cavity, it may land on a plate 25, which should be shaped to correspond to the bottom of the frozen confection, so that the shape of the bottom of the frozen confection is not altered. Alternatively, the frozen confection may be ejected in to a bath of a cryogenic fluid (such as liquid nitrogen) in order to harden the frozen confection, so that it may subsequently be handled without losing its shape. Once removed, the confections may be taken for further processing, for example hardening, coating in chocolate and packaging.

In the embodiment shown in FIGS. 24, the frozen confection is extruded vertically downwards; however this is not essential. The frozen confection could, for example, be extruded horizontally.

FIGS. 5(a) (perspective view) and 5(b) (side view) show a preferred embodiment where the mould block in which the cavities 18 are located is a rotating carousel 30. The nozzle is located at a filling station (not shown); the rotation of the carousel is indexed so that each cavity in turn is placed beneath the nozzle at the filling station. Once the cavity has been filled, the carousel rotates to the next index point, bringing the next cavity into position at the filling station. Further round the carousel is a removing station (also not shown) where the frozen confections are removed from the cavity, for example by the method shown in FIG. 4(d) and (e). FIG. 5(b) shows a side view of the carousel 30. The cross-sectional shape of the cavity 18 is achieved by varying the thickness of the carousel mould block radially across the cavity.

FIGS. 6 compares a product shaped by the conventional extrude and cut process ((a)-(c)) with a shaped product produced according to the present invention ((d)-(f)). Both products are shaped when viewed from above (FIGS. 6(a) and 6(d)). The side views show that the conventional product has a rectangular cross-section (FIG. 6(b)), whereas the product produced according to the present invention has a shaped cross-section (FIG. 6(e)). The perspective views (FIGS. 6(c) and 6(f) show the three-dimensional shapes of the products.

The various features and embodiments of the present invention, referred to in individual sections above apply, as appropriate, to other sections, mutatis mutandis. Consequently features specified in one section may be combined with features specified in other sections, as appropriate.

1. A process for shaping a frozen confectionery product, the process comprising:
extruding a frozen confection from a filling means into a cavity defined by a mould block and a base;
moving the mould block relative to the base; and
removing the frozen confection from the cavity
characterized in that the cross-section of the base, when viewed along the direction of relative motion of the cavity and the cutting means, is not a straight line.

2. A process according to claim 1 wherein the base is concave and the corresponding section of the mould block is convex when viewed along the direction of relative motion of the nozzle and the cavity, so that the shaped surface of the frozen confection is convex.

3. A process according to claim 1 wherein the filling means also has a cross-section which is not a straight line when viewed along the direction of relative motion of the mould block and the base,

4. A process according to any of claim 1 wherein a plurality of cavities is located in a rotating carousel and wherein the thickness of the carousel varies radially across the cavity.

5. An apparatus for shaping a frozen confectionery product, the apparatus comprising:
a mould block and a base which define a cavity,
a filling means for filling the cavity with frozen confection;
means for moving the mould block relative to the base;
means for removing the frozen confection from the cavity;
characterized in that the cross-section of the base, when viewed along the direction of relative motion of the cavity and the cutting means, is not a straight line.
